(19) United States
(12) Patent Application Publication
(10) Pub. No.: US 2019/0254920 A1
(43) Pub. Date: Aug. 22, 2019

(54) Sexual Compression Device

(71) Applicant: Jennifer Lynn Appel, Haleiwa, HI (US)

(72) Inventor: Jennifer Lynn Appel, Haleiwa, HI (US)

(21) Appl. No.: 15/901,516

(22) Filed: Feb. 21, 2018

(51) Int. Cl. A61H 19/00

(52) U.S. Cl. CPC A61H 19/32; A61H 2201/0111; A61H 19/50

(57) ABSTRACT

A device used by an individual or multiple individuals for sexual pleasure in various forms that replicates the proper functions of a female vagina. The art embodies a multi-directional moving, compression stimulation device for male, female or multiple partner sexual assistance, wherein control of the stimulation device may compress only one area of a lateral side, all radial portions or intermittent portions independently of other aspects by longitudinal contraction, as the device which may be a stand alone unit or placed into a second physical sexual aid, which could be any inanimate object with single or multiple openings or appendage protrusions, thereby providing for multiple individuals to additionally interact with multiple said compression stimulation devices at the same time each device operating independently or co-dependently and may incorporate aspects of prior art such as e.g. on/off buttons, electrical supply, temperature control, method of connection to the internet or reception of data information, location of internal or external fluid reservoir, specific hardware or software to operate said novel haptic teledildonic sexual compression device which is not claimed as inventive subject matter.

### CROSS REFERENCES CITED

U.S. Pat. No. 7,678,032B2 by Grant, 2004 Jun. 15

Jackson, Thomas; US 20170189263A1 application 2017 Jul. 6

Cambridge; U.S. Pat. No. 6,902,525B1 by Grant 2005 Jun. 7 to Jewell

No federally funded research

No sequence listing or appendix

### BACKGROUND OF THE INVENTION

The invention relates to a compression stimulation device used by a single individual or multiple individuals at the same time for sexual pleasure in various forms. Sexual stimulation devices for individuals or partners vary throughout the breadth of classification categories A61H19, A61F6, A61M2210, A61H2201, A61F5, Y10S128 and others, as sexual pleasure and satisfaction have been universally established as promoting physical and mental health as well as harmony within society at large. Currently, there are many speculations about the proper functions of a human female vagina and its orgasmic functions or capabilities. Few medical experts recognize internal vaginal fluid loss associated with a female orgasm or the method of contraction which activates said fluid loss which has been proven with video documentation. Furthermore, a properly functioning female vaginal orgasm with fluid loss from the internal vaginal canal as shown in video documentation parallels the compressive feeling of a “gag” reflex in a human throat. Whether with or without a partner or with multiple partners, extensive use of technology has aided significantly in allowing more people to achieve sexual satisfaction and understanding. This technology consists of an ever increasing vast array of sex machines, vibrators, and other sexual aids. Prior art in U.S. Pat. No. 7,678,032B2 by Grant, 2004 Jun. 15 to inventor Jackson, Thomas illustrates a sleeve with concentric rings to maintain an erection by constriction of the dorsal vein. U.S. Pat. No. 6,902,525B1 by Grant 2005 Jun. 7 issued to Stephen W Jewell offers a lateral motion masturbation device while US 20170189263A1 application dated 2017 Jul. 6 to Vivien Johan Cambridge teaches a masturbation unit to automatically apply lubricant. Radial sleeve compressive capability is uniform longitudinally in prior art. Prior art for sexual aids which is not claimed herein, in various forms embodies the capability to: 1) have a motor, 2) allow a motor to move a sleeve, 3) the sleeve has openings on both ends or only one end, 3) sleeve has a bi-directional lateral motion whether as a stand alone unit or embodied in other art, 4) may use bluetooth, GPRs technology, infrared technology, voice, visual, physical touch, auditory sensation or algorithm to move the sleeve, 5) may use bluetooth, wifi, voice, visual, auditory, pulse, breath rate or algorithm to cause the motor to react to a video or graphic motion, 6) may allow for a fluid tube, 7) may allow for an internal or external fluid reservoir, 8) may allow for cleaning the interior and exterior, 9) may have a manual switch to control volume of an auditory stimulus, 10) may contain a heating element aspect, 11) may include an electrical stimulation to cause muscle contraction, 12) vibrate, 13) may be utilized to maintain an erection, 14) may be used to provide clitoral stimulation, 15) may have internal replaceable batteries or a rechargeable battery, 16) have an external power supply and 17) have an on/off switch or any combination of the aforementioned. These prior art patents do not describe the novel and improved inventive subject matter for non-uniform compressibility or motion of the art claimed herein.

### APPLICATION OF THE INVENTIVE SUBJECT MATTER

For men who have an enlarged or small penis and do not believe the organ can fit comfortably into a human orifice, alternate option for men considering penile reduction or enlargement, stress relief. For male/male or male/female couples who may require assistance because of a size differential between partner A and partner B. For multiple partners engaged in like-minded activity without the benefit of contagion contraction.

May be used as an educational tool as the sexual compression device simulates the internal working of a properly functioning female vagina as shown in existing internally videoed media which is largely misunderstood by the general population.

### SUMMARY OF THE INVENTION

The device replicates the internal and physical actions of my properly functioning human female vagina in one embodiment. The device replicates the internal and physical actions of an oral cavity with “gag” reflex in another embodiment. The device replicates the compression “grip” of an appendage for masturbatory purposes in one embodiment. The device simulates compression in an anal cavity in one embodiment. The device replicates a compression and twisting capability in all embodiments and the device replicates physical movement with up to 360 degrees of movement in any direction chosen, as musculature contracts longitudinally rather than spherically. This application solves the delinquent defects missing from prior art as this device has the following stimulation aspects: 1) automated non-fluid, non-circular ring, compression pressure control at independent points of the longitudinal radial portion of a semi-rigid sleeve by internal sensors activated via an external source, 2) ability to release fluid from a separate source through perforations in the longitudinal sleeve in conjunction with compression stimuli and 3) the compression device may include up to 360 degree motion not just a lateral or bi-directional movement. In addition to the inventive subject matter claimed herein, the main distinguishing feature of the claims include the inventive method for application.

### BRIEF DESCRIPTION OF THE DRAWINGS

FIG. 1 is a drawing of the male anatomy (1) inserted into the compression sleeve (2) which has multiple perforations to allow fluid exudates (11) in a flexible space provided for sleeve movement (3) activating compression devices (12) inside the compression sleeves (2) with a waterproof hardware housing receptacle (4) inside an inanimate object shown in this view as a phallus (5) which could be inserted into another individual according to one embodiment.

FIG. 2 is a drawing of the male anatomy (1) inserted into the compression sleeve (2) with a waterproof hardware housing receptacle (4) inside an inanimate object (5) containing a flexible filling according to one embodiment.

FIGS. 3, 7, 8 are not shown.

FIG. 4 is a drawing of multiple compressive sleeves (2) in an anatomically correctly designed female doll (7) containing a flexible filling with a waterproof hardware housing receptacle (4) per sleeve inside the inanimate object according to one embodiment.

FIG. 5 is a drawing of the compression sleeve (2) portrayed in an oral cavity of an inanimate object illustrated in this view as a face with open mouth (6) with a waterproof hardware housing receptacle (4) inside an inanimate object head containing a flexible filling according to one embodiment.

FIG. 6 is a drawing of a closed hand (8) with an opening (9) in the circular first with a compression sleeve (2) inside the hand (8) around the circumference of the opening (9) and a waterproof hardware housing receptacle (4) inside the inanimate object containing a flexible filling according to one embodiment.

FIG. 9 is a drawing for multiple individual use at the same time showing two compression sleeves (2), one lower internal compression sleeve (2) which has multiple perforations to allow fluid exudates (11) installed in a flexible space provided for sleeve movement (3) with two waterproof hardware housing receptacles (4) activating compression devices (12) inside the compression sleeves (2) located inside an inanimate object shown in this view as a phallus (5) where the top compression sleeve (2) compresses outwardly and may behave independently of the interior compression sleeve (2) with multiple perforations to allow fluid exudates (11) could be inserted into another individual according to one embodiment.

### DETAILED DESCRIPTION OF THE INVENTION

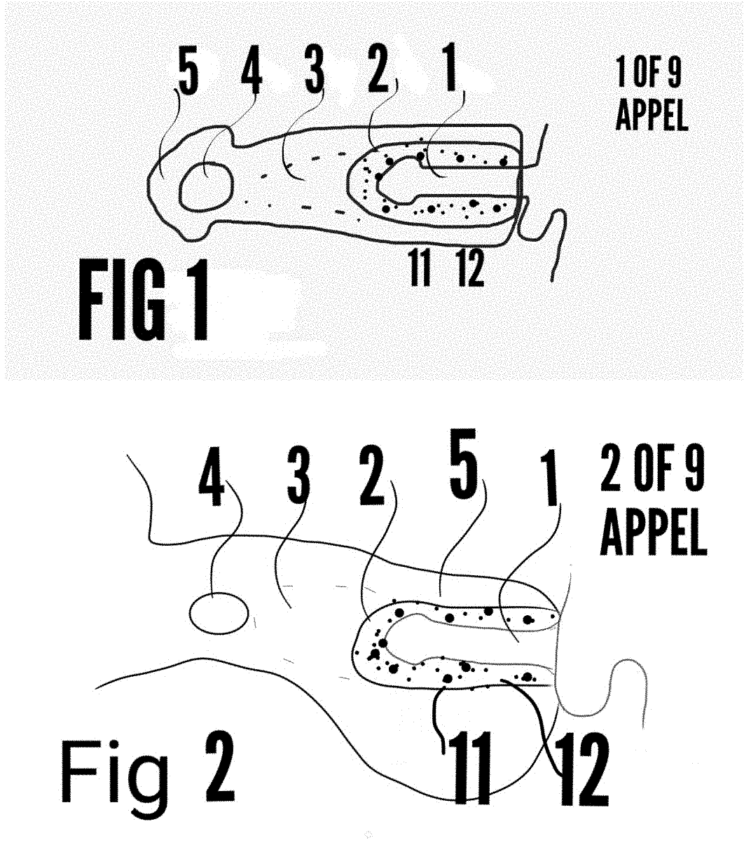

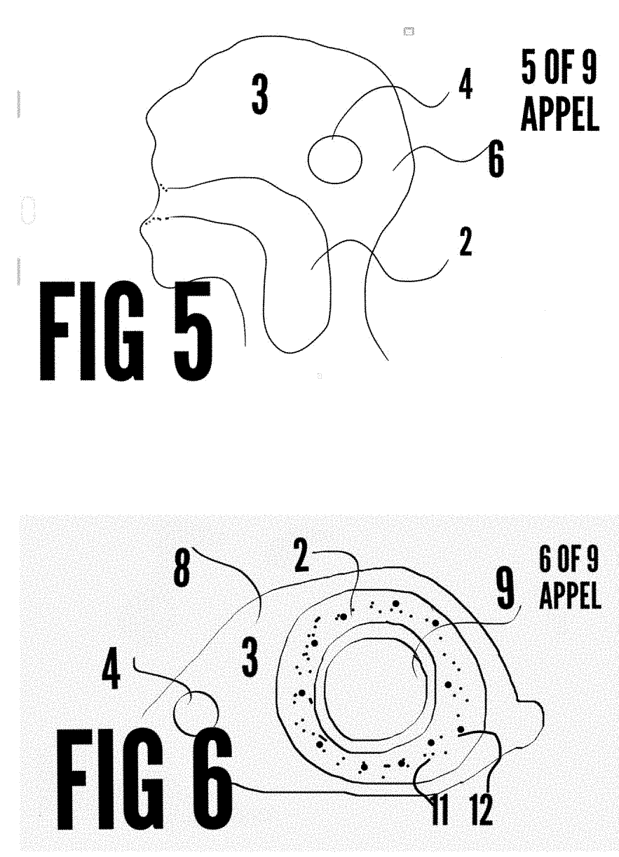

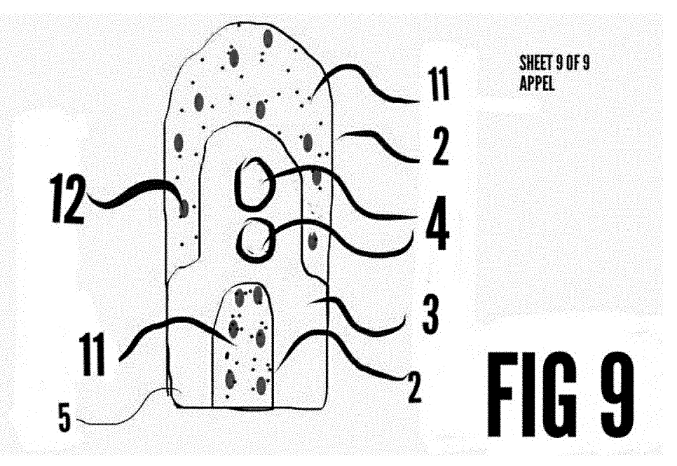

As illustrated in FIGS. 1-9, to incorporate the replicated compression device (2) with a waterproof hardware housing receptacle (4) in or on to an inanimate object (5), (6), (7), (8), activating compression devices (12) inside the compression sleeves (2) for single person use.

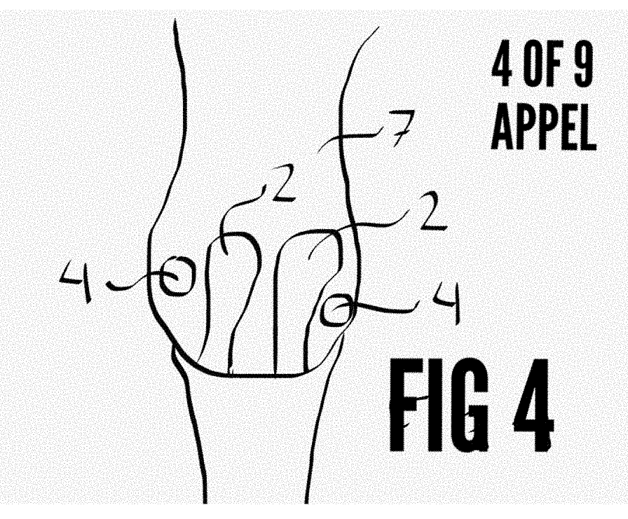

As illustrated in FIGS. 4 and 9, to incorporate multiple independently or co-dependently functioning compression devices (2) each with a waterproof hardware housing receptacle (4) in or on an inanimate object (5) for multiple person use.

Each device compression sleeve (2) is operated by sensors (12) via communication from the waterproof hardware housing receptacle (4). Activation via any chosen external stimuli including but not limited to pre-existing data, algorithm, electronic means, wifi, audio stimulus, visual stimulus, virtual stimulus, oratory stimulus, heart rate, touch or breath stimulus, the specific means of external communication with the hardware housing receptacle, while noted are not unique to the inventive subject matter, however, external stimuli allows for a second party other than the immediate user to interact with the user's hardware application.

Illustrated in FIG. 4, an inanimate object (5) with an internal flexible space (3) could be combined with additional internal openings or external appendages to form almost any configuration each with its own compression sleeve device (2) and waterproof hardware housing (4) capable of allowing each compression sleeve device (2) to move in multiple directions not just bi-directionally.

Combining the concepts in FIGS. 1-9, when said device is incorporated into an inanimate object (5) with multiple appendages for multiple person use at the same time, for example hands (8) with gripping capability, a “gag” reflex in an oral embodiment (6), or in another embodiment a ‘gag’ reflex (6) coupled with fluid exudates, or a compression causing swelling on the exterior of a phallus shaped object (5), the compression reaction in the sleeve (2) may be articulated, opposed or identical in each appendage (5), (6), (7), (8), as someone skilled in the art would understand.

The exact dimensions, external visual characteristics as well as specific option arrangements and their locations on or in the units will vary according to user requirements. Obvious examples include size variations in phallus length or girth, size and number of orifices or appendages, fluid release options, as one skilled in the art could conceive.

All embodiments for the use of the compression device technology are not shown for brevity however lack of a specified drawing should not preclude one skilled in the art to believe that the inclusion of this technology in an inanimate toy octopus containing one internal and nine external compression sleeve devices, hermaphroditic doll with five internal sleeve devices and one external sleeve device, modified chair, pillow, modified bathroom shower tile or glory box would construe the inventor's failure to consider the potentially limitless combination of available options for multiple applications with inanimate objects using this technology.

### CLASSIFICATIONS FOR THE ART

G06F3/011

A61F5/41

A61F6/04

A61H10/00

A61H19/30

A61H19/32

A61H19/40

A61H19/44

A61H23/0263

A61H2201/165

A61H2201/1207

A61H2201/1685

A61H2201/5007

A61H2201/5012

A61H2201/5058

A61H2201/5071

A61H2201/5097

A61M35/003

A61M2210/167

Y105128/918

What is claimed is:

1. A semi-rigid compression sleeve device consisting of:
(i) A semi-rigid material formed as a cylindrically shaped object with a hollow center with at least one open end replicating a human female vaginal canal, oral cavity, anal cavity or partially open fist; and
(ii) any portion of the semi-rigid compression sleeve device irrespective of other portions of the sleeve device may be compressed independently via method of sensors contracting in any longitudinal manner so as to provide for more than bi-directional movement as directed by an activated technology encased in the waterproof hardware housing; and
(iii) the compression sensation may be via nanotechnology, stimulated micro paddles or any methods replicating independent muscle contractions embedded throughout the semi-rigid compression sleeve.

2. A semi-rigid compression sleeve device comprising of perforations throughout the compression sleeve device which allow fluid to be disseminated through the compression sleeve while in contraction of specific device orifices during independent compression providing non-uniform release simulating realistic sensations to the user.

3. The semi-rigid compression sleeve may be independent or located with other semi-rigid compression sleeve devices in or on an inanimate object and each move independently or co-dependently in any direction via method of longitudinal contraction resulting in the feeling of compression, including angular twisting of an independent cross section allowing for more sensation than just bi-directional capacity.
